(19) United States
(12) Patent Application Publication
(10) Pub. No.: US 2023/0304591 A1
(43) Pub. Date: Sep. 28, 2023

(54) IN-LINE MEDIUM PRESSURE VALVE

(71) Applicant: BayoTech, Inc., Albuquerque, NM (US)

(72) Inventors: Stephen A. Carter, Albuquerque, NM (US); Michael Koonce, Albuquerque, NM (US)

(21) Appl. No.: 17/703,533

(22) Filed: Mar. 24, 2022

(51) Int. Cl. F16K 11/087; F16K 5/06

(52) U.S. Cl. CPC F16K 11/087; F16K 5/0663

(57) ABSTRACT

A valve includes a housing, a ball rotatably coupled to the housing, a handle coupled to the ball, a ball retainer coupled to the housing, and a radial seal. The housing includes an inlet, an outlet, a passage between the inlet and the outlet, and a lower housing bore. The ball includes a body, a lower trunnion, and an opening through the body. The handle is operable by a user to rotate the ball in the housing to align the opening with the passage of the housing to open the valve. The ball retainer retains the ball in the housing. The ball retainer includes a threaded portion and a shaft portion in the lower housing bore. The radial seal is between the shaft portion and the lower housing bore.

### BACKGROUND

Systems for handling, storing, and transporting gases, such as hydrogen gas, at elevated pressure depend on shut-off valves that can perform reliably in harsh environments and under severe duty cycles.

### SUMMARY

We describe in-line valves for gases, such as hydrogen gas under medium pressure. In some implementations, valves have maximum working pressures of 15,000 and 20,000 psi.

In one general aspect, a valve includes a housing, a ball rotatably coupled to the housing, a handle coupled to the ball, a ball retainer coupled to the housing, and a radial seal. The housing includes an inlet, an outlet, a passage between the inlet and the outlet, and a lower housing bore. The ball includes a body, a lower trunnion, and an opening through the body. The handle is operable by a user to rotate the ball in the housing to align the opening with the passage of the housing to open the valve. The ball retainer is configured to retain the ball in the housing. The ball retainer includes a threaded portion and a shaft portion at least partially disposed in the lower housing bore. The radial seal is between the shaft portion and the lower housing bore.

Implementations can include one or any combination of the following features.

The valve further includes a seal back-up ring at least partially disposed in the external groove. The valve further includes a seal back-up ring is configured to inhibit the radial seal from being displaced from the external groove under pressure.

The shaft portion of the ball retainer defines an external groove. The radial seal is at least partially disposed in the external groove.

The external groove is beneath the threaded portion of the ball retainer.

The valve includes a seal back-up ring. The seal back-up ring inhibits the radial seal from being displaced under pressure

The valve includes a seal back-up ring at least partially disposed in the external groove. The seal back-up ring inhibits the radial seal from being displaced from the external groove under pressure.

The radial seal includes an O-ring.

The valve includes one or more ball seals that bear against the body of the ball.

At least one of the one or more ball seals includes PEEK.

At least one of the one or more ball seals includes a PEEK material reinforced with PTFE, graphite, and carbon fiber.

At least one of the one or more ball seals forms a spherical face seal with the ball.

The ball retainer defines a retainer bore in which at least a portion of the lower trunnion resides. The lower trunnion is configured to rotate in the retainer bore.

The valve further includes a bearing between an outer surface of the lower trunnion and an inner surface of the retainer bore.

The valve further includes one or more adapters coupled in at least one of the inlet and the outlet of the housing.

The valve further includes one or more adapter retaining rings. At least one of the one or more adapter retaining rings is configured to inhibit at least one of the one or more adapters from improperly turned out of the housing when the valve is pressurized (i.e. whether accidentally or by tampering).

The adapter retaining ring includes an internal retaining ring (e.g., snap ring).

At least one of the adapters includes a threaded portion and a shaft portion. The shaft portion includes an adapter external groove. The valve further includes an adapter radial seal disposed in the adapter external groove.

The radial seal is beneath the threaded portion of the adapter.

The valve further includes a seal back-up ring at least partially disposed in the adapter external groove. The seal back-up ring is configured to inhibit the adapter radial seal from being displaced from the adapter external groove under pressure.

At least one of the one or more adapters includes an adapter bore. The valve further includes a ball seal on at least one side of the ball, a ball seal carrier configured to hold the ball seal, and a carrier radial seal between the an outer surface of the ball seal carrier and an inner surface of the adapter bore.

The valve further includes a seal back-up ring configured to inhibit the carrier radial seal from being displaced under pressure.

An exterior surface of the ball retainer is flush with or recessed from a bottom surface of the housing.

The valve further includes a stem between the ball and the handle and passing through an upper bore of the housing, and a stem radial seal. The stem includes a stem external groove. The stem radial seal is at least partially disposed in the stem external groove.

The valve further includes a seal back-up ring at least partially disposed in the stem external groove. The seal back-up ring is configured to inhibit the stem radial seal from being displaced from the stem external groove under pressure.

The ball includes an upper trunnion.

The housing defines one or more weep holes. At least one of the one or more weep holes includes an opening on an exterior surface of the housing in fluid communication with at least one seal of the valve.

At least one of the one or more weep holes is configured to permit detection of leaks from the valve.

The housing defines two or more weep holes. At least two of the two or more weep holes includes an opening on the exterior surface of the housing.

The valve includes two or more radial seals. Each of at least two of the two or more weep holes is in fluid communication with a different one of the two or more radial seals. At least one of the openings is in fluid communication with a radial seal of the valve. At least one of the openings is in fluid communication with a cone or threads of an adapter coupled in the housing.

The valve further includes a pin removably coupled to the handle. The pin is configurable to lock a position of the valve.

The pin is configured to pass through an opening in the handle to lock the position of the valve.

The valve further includes a finger ring coupled to the pin.

The valve further includes a lanyard coupled between the pin and the housing.

The valve further includes a padlock configurable to lock the pin in place in the handle.

In another general aspect, a valve includes a housing, a ball rotatably coupled to the housing, a handle coupled to the ball, one or more components including a threaded portion, and one or more radial seal sets. The housing includes an inlet, an outlet, a passage between the inlet and the outlet, and one or more internally threaded portions. The ball includes a through opening. The handle is operable by a user to rotate the ball in the housing to align the through opening with the passage of the housing to open the valve. At least one of the one or more components is coupled in one of the internally threaded portions of the housing. The one or more radial seal sets are configured to inhibit gas from leaking from the passage past the at least one component. At least one of the radial seal sets includes a radial seal and a seal back-up ring. The seal back-up ring is configured to inhibit the radial seal from being displaced under pressure. At least one of the radial seals is beneath the threaded portion of the at least one component.

Implementations can include one or any combination of the following features.

At least one component includes a ball retainer.

At least one component includes an inlet adapter.

At least one component includes a groove. The seal back-up ring is configured to inhibit the radial seal from being displaced from the groove under pressure.

In another general aspect, a valve includes a housing, a ball rotatably coupled to the housing, a handle coupled to the ball, one or more adapters threadably coupled to the housing, and one or more adapter retaining rings. The housing includes an inlet, an outlet, and a passage between the inlet and the outlet. The ball includes a through opening. The handle is operable by a user to rotate the ball in the housing to align the through opening with the passage of the housing to open the valve. At least one of the one or more adapter retaining rings is configured to inhibit at least one of the one or more adapters from backing out of the housing under pressure.

In another general aspect, a valve includes a housing, a ball rotatably coupled to the housing, a handle coupled to the ball, and two or more seals. The housing includes an inlet, an outlet, and a passage between the inlet and the outlet. The ball includes a through opening. The two or more seals are configured to inhibit gas from leaking from the passage. The housing defines two or more weep holes. At least two of the two or more weep holes include an opening on an exterior surface of the valve. Each of at least two of the two or more weep holes is in fluid communication with a different one of the two or more seals.

In another general aspect, a system for detecting leakage from a valve includes a leak detector and a leak collector. The leak collector includes one or more passages in fluid communication with the leak detector. The leak collector collects gas leaked from one or more weep holes on the valve into at least one of the one or more passages. The leak detector detects leaks from the valve from the gas collector in the at least one passage in the leak collector.

The approaches described here can have one or more of the following advantages: Seals do not blow out under pressure. Joints do not loosen or leak with high pressure impulses/cycles. Seals are beneath the threads so pressure does not expand ports. The risk that a seal will be compromised by tampering is reduced. The risk of accidental loosening or back-out of inlet adapters is reduced. Valve performance is less susceptible to one or any combination of the following: under-torqued joints, imperfect machining (flatness and/or perpendicularity of seating faces), debris/contaminants between valve and fitting preventing seating; and/or weak sections yielding from repeated pressure cycles. Maintenance personnel can determine visually whether parts are properly installed and sealing. Leaks can be isolated to particular leak sites. Leak detection is less susceptible to uncertainty due to random thread variations. The valve and/or the valve installation are more compact.

The details of one or more implementations are set forth in the accompanying drawings and the description below. Other features and advantages will be apparent from the description and drawings, and from the claims.

### BRIEF DESCRIPTION OF DRAWINGS

FIG. 1 is a perspective view of an in-line valve according to an illustrative implementation.

FIG. 2 is a cross sectional view of the in-line valve of FIG. 1.

FIG. 3 is a detail cross sectional view of the bottom central portion of the valve of FIG. 1.

FIG. 4 is a detail cross sectional view of the upper central portion of the valve of FIG. 1.

FIG. 5 is a detail cross sectional view of the left side of the valve of FIG. 1.

FIG. 6 is a detail cross sectional view of a connection between a seal carrier and an inlet adapter.

FIG. 7 is an exploded view illustrating the components that retain a ball in a housing.

FIG. 8 is an exploded view illustrating the components in an inlet opening.

FIG. 9 illustrates a valve including a set of weep holes defined on one side of the valve body for permitting leak detection.

FIG. 10 is a cross sectional view of a side portion of a valve taken along lines 10-10 of FIG. 9.

FIG. 11 is a cross sectional view of a lower portion a valve taken along lines 11-11 of FIG. 9.

FIG. 12 is a cross sectional view of an upper portion of a valve taken along lines 12-12 of FIG. 9.

FIG. 13 is a perspective view of a leak collector installed on a valve.

FIG. 14 is a cross sectional view of a leak collector installed on a valve taken along lines 14-14 of FIG. 13.

FIG. 15 is a perspective view showing the back side of the leak collector of FIG. 13.

FIG. 16 is a cross sectional view of leak collector taken along lines 16-16 of FIG. 15.

FIG. 17 is a perspective view illustrating one implementation of a handle locking device that can be used in the valve of FIGS. 1 and 2.

FIG. 18 is a cross sectional view of the valve of FIG. 17 with a handle locking device in which the valve is in a closed position.

FIG. 19 is a cross sectional view of the valve with a handle locking device in which the valve is in an open position.

FIGS. 20 and 21 are perspective views of a secondary locking system that can be used to prevent release of a handle locking device.

FIG. 22 is a perspective view of the secondary locking system of FIGS. 20 and 21.

FIG. 23 is a perspective view illustrating mounting components of a valve.

FIG. 24 is a cross sectional view illustrating an exemplary form of mounting of a valve to a surface.

### DETAILED DESCRIPTION

We describe in-line manual valves for gases, such as hydrogen gas under medium pressure. In some implementations, valves have maximum working pressures of 15,000 and 20,000 psi.

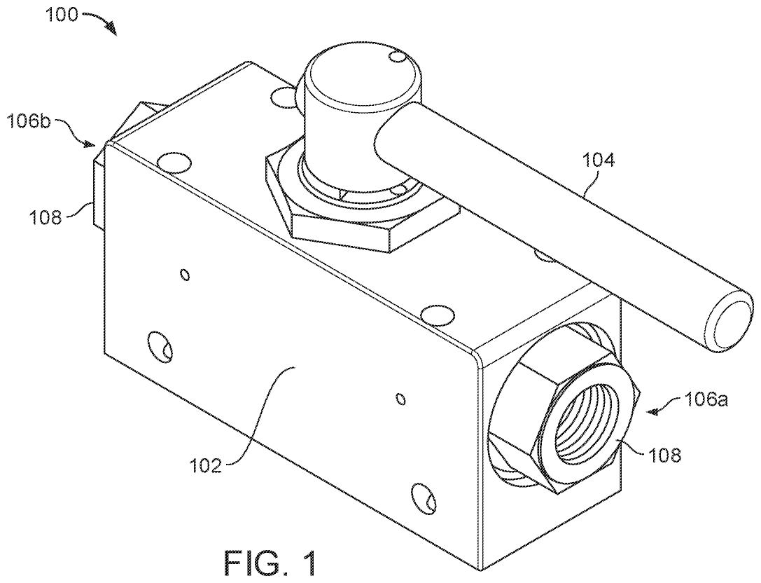

FIG. 1 is a perspective view of an in-line, medium-pressure valve 100. Valve 100 includes housing 102 and handle assembly 104. Housing 102 defines a passage from an opening 106a on one end of housing 102 to an opening 106b on the other end of housing 102. Adapters 108 are installed in housing 102 in each of openings 106a and opening 106b. One of the openings 106a, 106b can serve as an inlet and the other of openings 106a, 106b can serve as an outlet for gas passing through the valve. As further described below, handle assembly 104 can be manually, semi-automatically, or automatically operated to open or close valve 100 to control the flow of gas between openings 106a and 106b and through the valve 100.

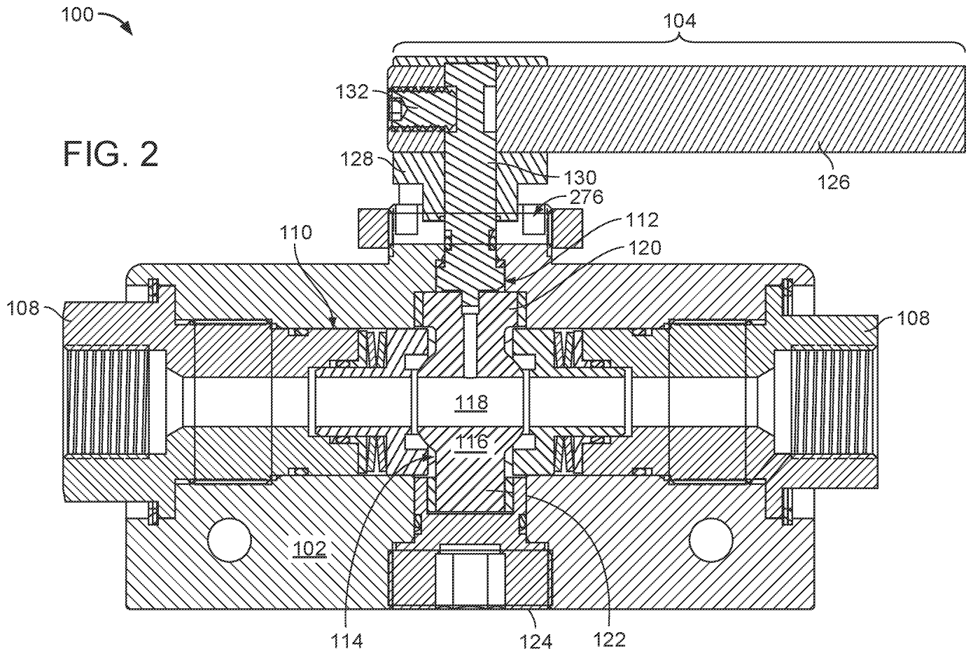

FIG. 2 is a cross sectional view of the in-line valve 100 of FIG. 1. Housing 102 defines a passage 110 that extends through housing 102 horizontally between opening 106a on one end of housing 102 and opening 106b on the opposite end of housing 102. Housing 102 also defines a central bore 112 that extends vertically from top to bottom of housing 102 and intersects passage 110.

Valve 100 includes ball 114. Ball 114 is rotatably coupled to housing 102 in central bore 112 of housing 102. Ball 114 includes a body 116, hole 118, upper trunnion 120, and lower trunnion 122. Ball 114 can be rotated on upper trunnion 120 and lower trunnion 122 such that hole 118 aligns with passage 110 to open valve 100. In one example, ball 114 is 316 stainless steel.

Ball 114 is retained in housing 102 by ball retainer 124. In this example, the bottom surface of ball retainer 124 is flush with the bottom surface of housing 102. In other implementations, the bottom surface of a ball retainer is recessed with respect to the bottom surface of a valve housing.

Handle assembly 104 includes handle 126 and hub 128. Handle assembly 104 is coupled to ball 114 by way of valve stem 130. Set screw 132 secures handle assembly 104 to valve stem 130. Valve stem 130 passes through the top portion of central bore 112 of housing 102. Handle 126 is rotatably coupled to valve stem 130. Valve stem 130 is rotatably coupled to ball 114. Rotation of handle 126 produces corresponding rotation of ball 114. Rotation of handle 126 may be performed by manual, semi-automatic, or automatic methods. Valve 100 may include a high-flow bore, where the bore is at least as large as the ID of the tube or fitting attached to the valve. For example, the valve version shown is configured for 9/16″ MP tubing and has a thru bore of valve 100 (including hole 118) of 0.359 inches. That is equal to or greater than the thru bores of 9/16″ tubing: 10,000 psi tubing ID=0.359″; 20,000 psi tubing ID=0.312″. Examples of other inlet forms versus the valve's bore 100 are shown below:

| Inlet | Tube OD × | Size | Tubing | Adaptor | Valve |
|---|---|---|---|---|---|
| format | wall thickness | ID | ID | bore | bore |
| Medium | 9/16″ × 0.102″ | LF9 | 0.359″ | 0.359″ | 0.359″ |
| pressure | 9/16″ × 0.125″ | | 0.312″ | 0.359″ | |
| (MP) | ⅜″ × 0.086″ | LF6 | 0.203″ | 0.219″ | |
| | ¼″ × 0.071″ | LF4 | 0.109″ | 0.125″ | |
| SAE | ½″ × 0.083″ | SAE-8 | 0.334″ | 0.359″ | |
| ORB | ⅜″ × 0.083″ | SAE-6 | 0.209″ | | |
| NPT | ½″ × 0.083″ | ⅜″ NPT | 0.334″ | | |

The valve can be up-scaled or down-scaled to accommodate even smaller or even larger tube sizes.

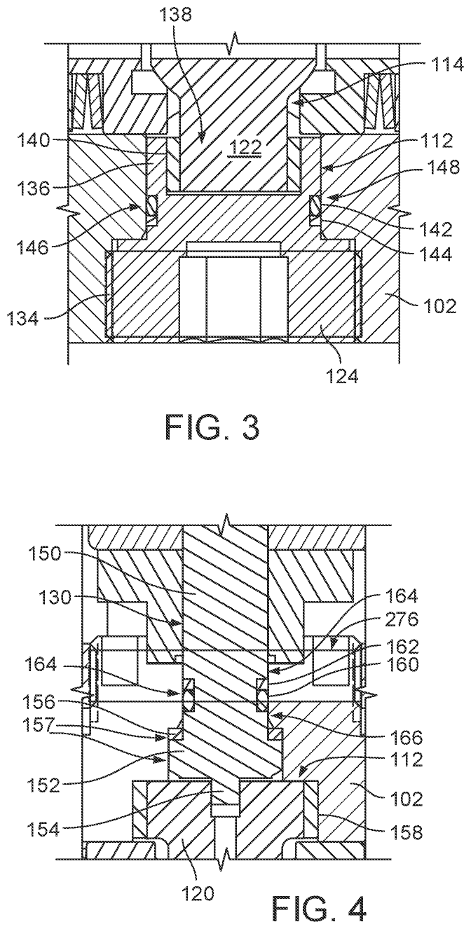

FIG. 3 is a detail cross sectional view of the bottom central portion of valve 100. Ball retainer 124 is threaded into the lower portion of central bore 112. Ball retainer 124 includes threaded portion 134 and shaft portion 136. Lower trunnion 122 engages in trunnion socket 138. Bearing 140 is disposed between lower trunnion 122 and the inner wall of trunnion socket 138.

Valve 100 includes radial seal 142 and back-up ring 144. In this example, radial seal 142 is an O-ring. Radial seal 142 and back-up ring 144 are located in groove 146 formed in shaft portion 136 of ball retainer 124. Radial seal 142 and back-up ring 144 form ball retainer seal set 148. Radial seal 142 may be compressed between the bottom of groove 146 and the adjacent inner wall of housing 102. As further described below, radial seal 142 inhibits leakage of gas between housing 102 and ball retainer 124. Back-up ring 144 keeps radial seal 142 from being displaced from groove 146 under pressure in valve 100, thus preventing seal blowout at ball retainer 114.

In various implementations described herein, a radial seal includes an external groove for an O-Ring and back-up ring to reside in (in the example shown in FIG. 3, groove 146). In alternate implementations, a radial seal uses an internal groove to accommodate an O-Ring, back-up ring, or both. For example, an internal groove can be provided in an inner wall of central bore 112 of housing 102.

FIG. 4 is a detail cross sectional view of the upper central portion of valve 100. Valve stem 130 includes valve stem shaft 150, base portion 152, and tab 154. Thrust bearing 156 is disposed between a lip 157 of valve stem 130 and the adjacent step in central bore 112. Bearing 158 is disposed between upper trunnion 120 and an inner wall of central bore 112.

Valve 100 includes radial seal 160 and back-up ring 162. In this example, radial seal 160 is an O-ring. Radial seal 160 and back-up ring 162 are located in groove 164 in valve stem shaft 150. Radial seal 160 and back-up ring 162 form stem seal set 166. In this example, radial seal 160 is compressed between the bottom of groove 164 and the adjacent inner wall of housing 102. Radial seal 160 inhibits leakage of gas between housing 102 and valve stem 130. Back-up ring 162 keeps radial seal 160 from being displaced from groove 166 under pressure in valve 100, thus preventing seal blowout at valve stem 130.

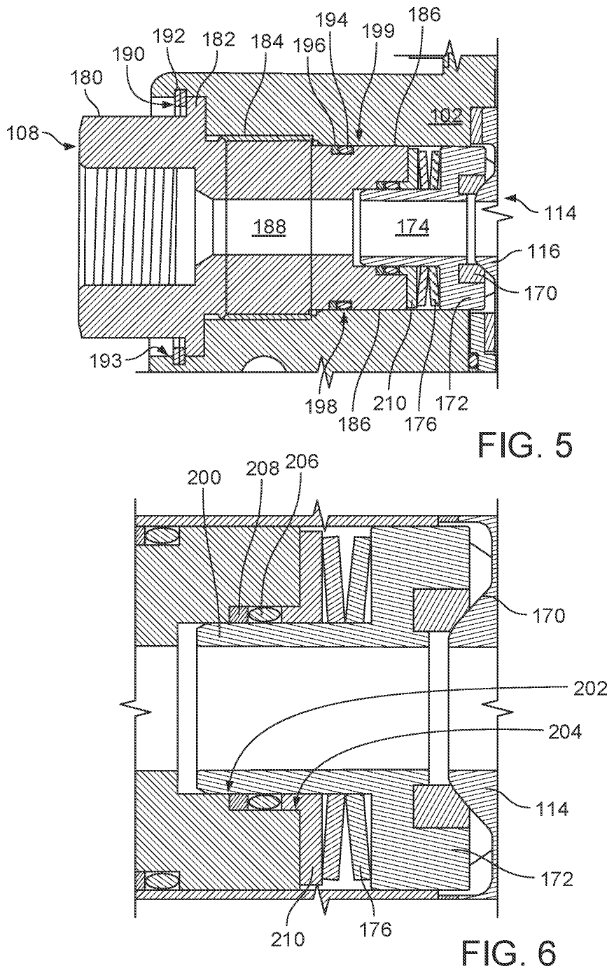

FIG. 5 is a detail cross sectional view of the left side of valve 100. On either side of ball 114, a ball seal 170 bears against ball 114 (see also FIG. 2). Each ball seal 170 is held in a seal carrier 172. Each seal carrier 172 defines an opening 174 through which gas can flow. One or more Belleville springs 176 are disposed between each of adapters 108 and the corresponding seal carrier 172 in passage 110. With adapters 108 installed in housing 102, Belleville springs 176 urge ball seals 170 into engagement with an exterior surface of body 116 of ball 114. Preload on ball seals 170 provided by Belleville spring 176 may enhance sealing at very low pressures (e.g., 50 to 500 psi). In one implementation, each of ball seals 170 forms a spherical face seal with ball 114.

In the implementation shown in FIG. 5, each side of valve 100 includes two Belleville springs that are arranged in series. In other implementations, Belleville springs can be arranged in parallel, or series-parallel. Each side of valve 100 can include one Belleville spring, or three or more Belleville springs.

Each of adapters 108 includes head portion 180, rim 182, threaded portion 184, and shaft portion 186. Each adapter 108 defines an adapter bore 188 through which gas can flow. The rim 182 of each of the adapters rests in a seat 190 of housing 102. Valve 100 includes adapter retaining rings 192. Each of adapter retaining rings 192 engages in a groove 193 of housing 102 adjacent to seat 190 of the housing. In this example, adapter retaining rings 192 are snap rings.

Valve 100 includes radial seal 194 and back-up ring 196. In this example, radial seal 194 is an O-ring. Radial seal 194 and back-up ring 196 are located in groove 198 in shaft portion 186 of adapter 108. Radial seal 194 and back-up ring 196 form adapter seal set 199. Radial seal 194 may be compressed between the bottom of groove 198 and the adjacent inner wall of housing 102. Radial seal 194 inhibits leakage of gas between housing 102 and adapter 108. Back-up ring 196 keeps radial seal 194 from being displaced from groove 198 under pressure in valve 100, thus preventing seal blowout at adapter 108.

FIG. 6 is a detail cross sectional view of a connection between seal carrier 172 and adapter 108. Seal carrier 172 includes shaft portion 200. The leading edge of shaft portion 200 of seal carrier 172 slides into first bore 202 and second bore 204 of adapter 108. First bore 202 has a smaller diameter than second bore 204. Radial seal 206 and backup ring 208 are contained by gland end 210 in the annular space between the outer surface of shaft portion 200 and the inner surface of second bore 204. In this example, radial seal 206 is an O-ring. Radial seal 206 may be compressed between the outer surface of shaft portion 200 and the inner surface of second bore 204. Radial seal 206 inhibits leakage of gas between seal carrier 172 and adapter 108. Back-up ring 208 keeps radial seal 206 from being displaced from second bore 204 under pressure in valve 100, thus preventing seal blowout at seal carrier 172.

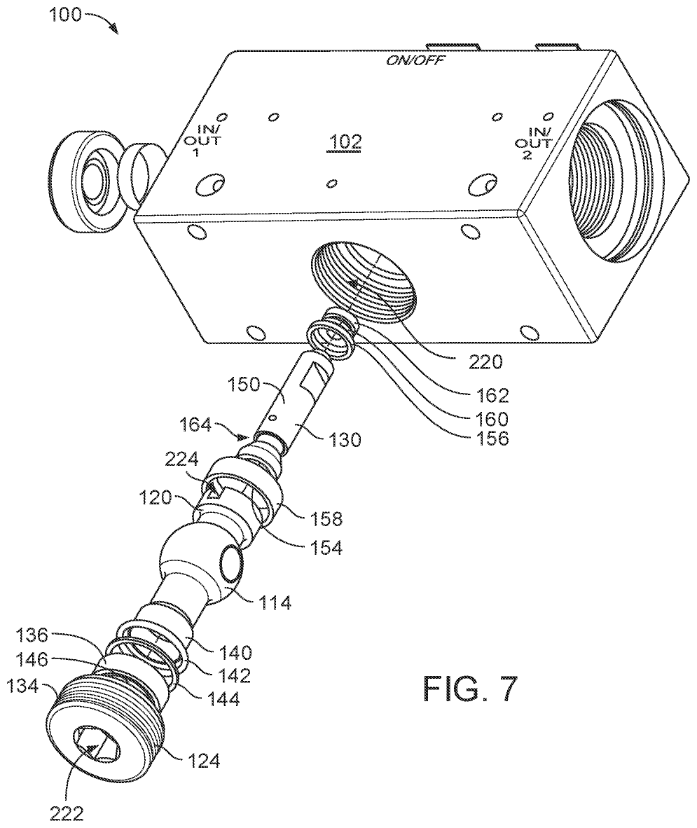

FIG. 7 is an exploded view illustrating the components associated with ball 114. Ball retainer 124 is installed in threaded portion 220 of housing 102. Ball retainer 124 includes hex socket 222 for driving ball retainer 124. Shaft portion 136, valve stem shaft 150, and the bottom of grooves 146 and groove 164 can have smooth surfaces. Radial seal 142 and back-up ring 144 can be positioned in groove 146. Radial seal 160 and back-up ring 162 can be positioned in groove 164. Tab 154 of valve stem 130 couples in slot 224 in upper trunnion 120.

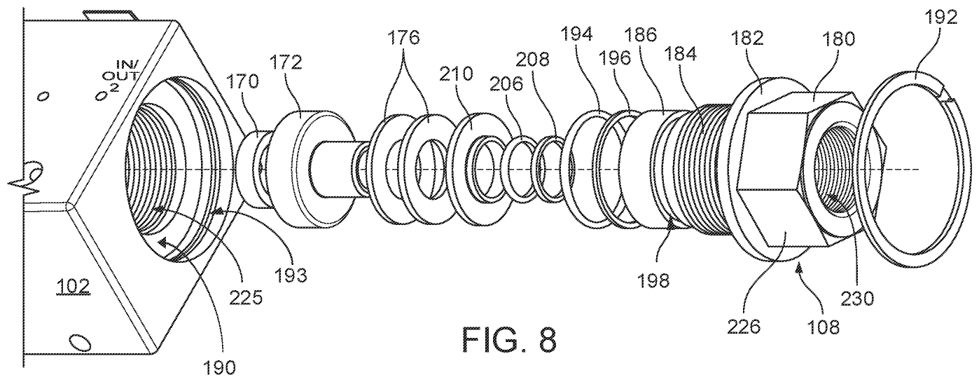

FIG. 8 is an exploded view illustrating the components in one of openings 106a, 106b. Adapter 108 is installed in threaded portion 225 in housing 102. Adapter 108 includes hex flats 226. Hex flats 226 can be used to drive adapter 108. When installed, rim 182 bears against seat 190. Retaining ring 192 can snap into groove 193 of housing 102. Shaft portion 186 of adapter 108 and the bottom of groove 198 can have smooth exterior surfaces. Radial seal 194 and back-up ring 196 can be positioned in groove 198.

Adapter 108 includes connecting portion 230. Connecting portion 230 of the selected adapter can vary depending on the type of fitting to connect valve 100 to the system. In one example, a valve system includes adapters for each of the following optional inlets: in MP tube format: 9/16″ (LF9), ⅜″ (LF6), and ¾″ (LF4); in SAE ORB format: ½″ (SAE-8), ⅜″ (SAE-6) and ¾″ (SAE-4); and in NPT format: ⅜″-18 NPT and ¾″-18 NPT.

Material for ball-seals and bearings can be high strength, high PV, and low friction. In one implementation, ball seals are made of bearing-grade PEEK reinforced with PTFE, graphite, carbon fiber. Examples of other materials that can be used for ball-seals and bearings can include PEEK, PTFE, or Nylatron®, produced by Mitsubishi Chemical Advanced Materials. O-rings can be low friction, ultra-long life, and high-temperature tolerant.

In one example, O-ring compounds have a specified Trio of −50° C. (−58° F.) and a brittleness temperature of −68° C. (−90° F.). Backup ring compounds have a specified Trio of −42 C (−44° F.) and a brittleness temperature of −44° C. (−47° F.). Backup rings can be shaped. The radial seals can provide gas-tight sealing.

In one example, the body and seals of valve 100 are each rated for 15,000 pounds per square inch (psi). Seals can be rated for −50 degrees C.

In some implementations, a valve includes openings that facilitate detection of gas leakage. The openings can be in the form of weep holes formed in the body of the valve. Each weep hole can be in fluid communication with one or more potential leak sites within the valve.

In one example, each weep hole on the valve connects directly to a single potential leak site. In the event of a leak from a particular site, gas can escape directly through the associated weep hole and be detected by appropriate gas detection systems or devices, or in certain examples, by a human operator working nearby. The weep holes can also prevent pressure from building up on larger downstream surface areas.

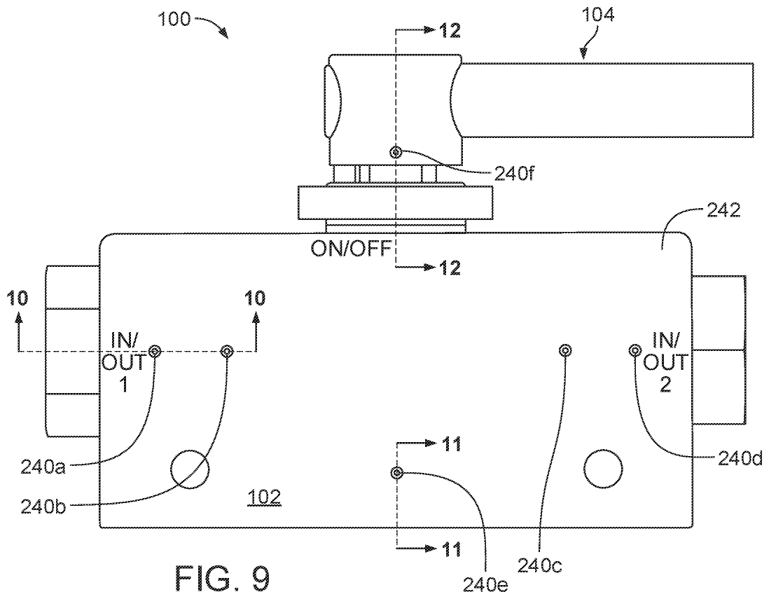

In some implementations, two or more weep holes are formed on the same side of a valve. FIG. 9 illustrates a valve including a set of weep holes formed on one side of a valve for permitting gas leak detection. Valve 100 includes weep holes 240a, 240b, 240c, 240d, 240e, and 240f. Weep holes 240a-e are located on front face 242 of body 102 of valve 100. Weep holes 240a, 240b, 240c, and 240d are on the centerline of valve 102. Weep hole 240f is located on a surface of hub 128 of handle assembly 104. Each of weep holes 240a-f is in fluid communication with a different potential leak site of valve 100. In other implementations, one or more of weep holes 240a-f may be in fluid communication with one or more different potential leak sites of valve 100.

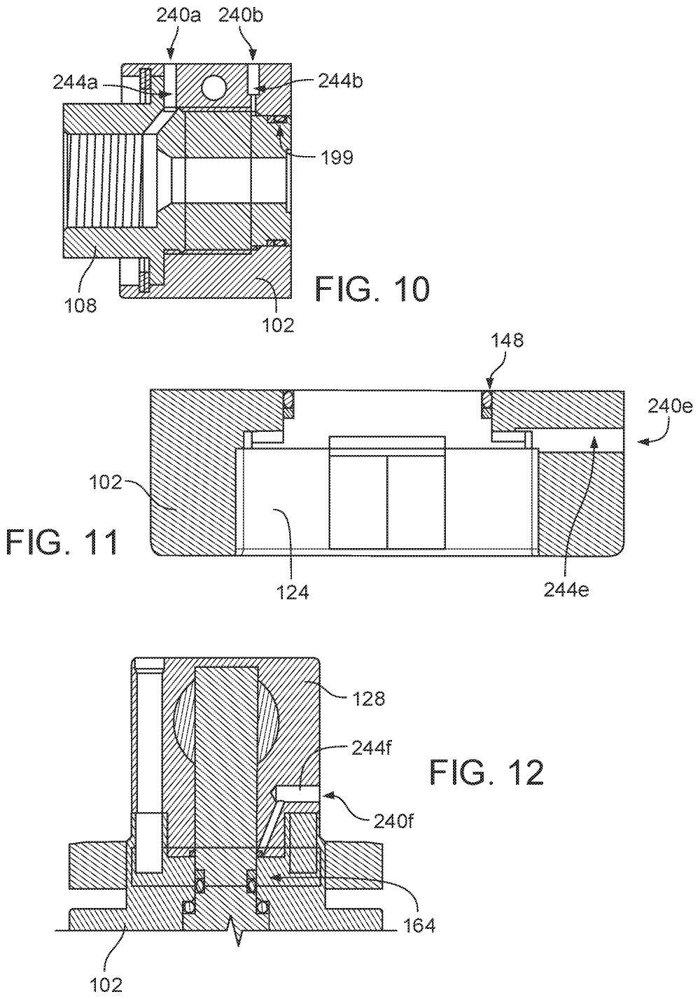

FIG. 10 is a cross sectional view of a side portion of valve 100 taken along lines 10-10 of FIG. 9. Weep holes 240a and 240b are on the centerline of the valve 100. A passageway 244a is formed between weep hole 240a and the end of the threads of connecting portion 230 of adapter 108, or in the runout area of the threads.

A passageway 244b is formed between weep hole 240b and the area between threaded portion 246 and adapter seal set 199. Passageways 244a and 244b can include one or more drilled holes.

Weep hole 240a can capture leakage past the medium pressure cone and thread joints (e.g., 9/16 inch, ⅜ inch, or ¼ inch MP tube). If the valve has an SAE or NPT inlet adapter, weep hole 240a can be machined into the body 102. Weep hole 240a may or may not connect to the interior of an installed fitting. Weep hole 240b can capture leakage past adapter seal set 199.

Weep holes 240d and 240c and their associated passageways can be a mirror image of that shown for weep holes 240a and 240b in FIG. 10.

FIG. 11 is a cross sectional view of a lower portion valve 100 taken along lines 11-11 of FIG. 9.

Weep hole 240e is located on the same surface of housing 102 as weep holes 240a, 240b, 240c, and 240d. A passageway 244e is formed between weep hole 240e and an area between threaded portion 134 and ball retainer seal set 148. Passageway 244e can include one or more drilled holes. Weep hole 240e can capture leakage past ball retainer seal set 148.

FIG. 12 is a cross sectional view of an upper portion of valve 100 taken along lines 12-12 of FIG. 9. Weep hole 240f is located on a surface of hub 128 such that, when handle assembly 104 is in the open position, weep hole 240f is on the same side of valve 100 as weep holes 240a, 240b, 240c, 240d, and 240e. A passageway 244f is formed between weep hole 240f and valve stem 130 above stem seal set 164. Passageway 244e can include one or more drilled holes. Weep hole 240f can capture leakage past stem seal set 164.

In some implementations, a system includes a leak detection system for capturing or sensing leakage gas from the weep holes of a valve. The leak detection system can include a leakage detection device(s) and a manifold that connects the leak detection device with each of two or more of the weep holes. In one example, a leakage detection system senses, logs, and reports leakage from each of weep holes 240a, 240b, 240c, 240d, 240e, and 240f. Information from the leakage detection system can be used to isolate leakage sites in the valve and guide diagnosis, maintenance and repair of the valve.

In some implementations, a valve is coupled to a leak detection system. The leak detection system can include a leak detector, and a leak collector coupled to the leak detector. The leak collector can be installed on the valve to collect gas leaking from weep holes or points of leakage on the valve.

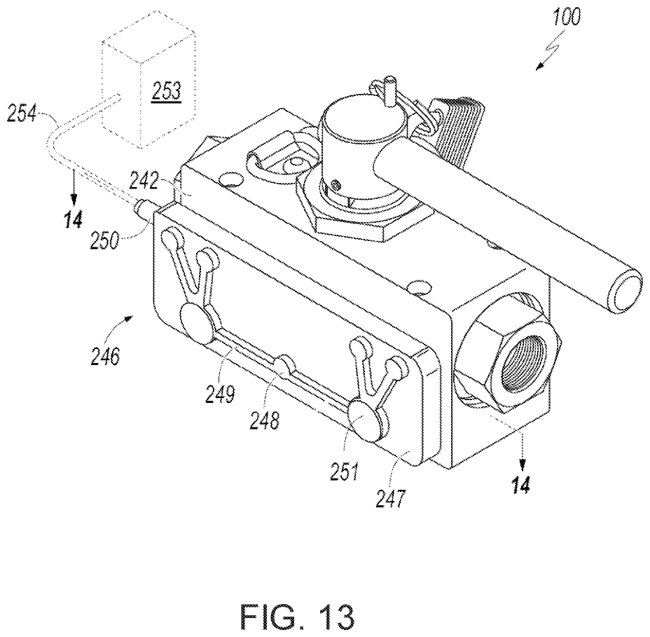

FIG. 13 is a perspective view of a leak collector 246 installed on valve 100. Leak collector 246 includes leak detector body 247. Bosses 248 and stiffening ridges 249 are provided on an outer surface of body 247. Tube stub 250 is provided on an edge of body 247. Leak collector 246 can be installed on front face 242 of valve 100 (see FIG. 9). Leak collector 246 can collect leakage from weep holes 240 on front face 242 (shown as 240a, 240b, 240c, 240d, and 240e in FIG. 9). Fasteners 251 secure leak collector 246 to valve 100. In one implementation, fasteners 251 are carriage bolts that couple each couple with a corresponding nut on the opposite side of body 102. Leak collector 246 can be connected to leak detector 253 by way of a fluid line 254 (e.g., a tube) connected to tube stub 250.

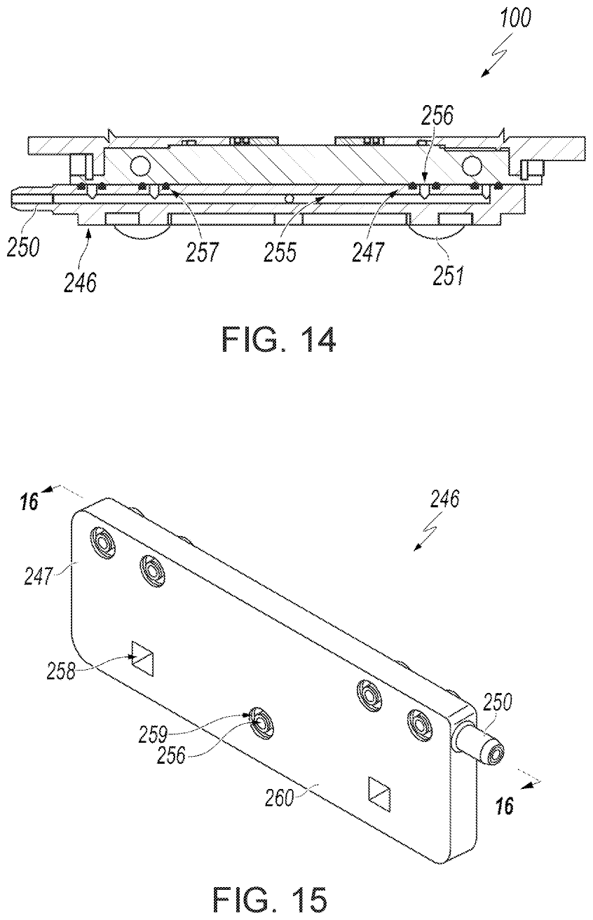

FIG. 14 is a cross sectional view of leak collector 246 installed on valve 100 taken along lines 14-14 of FIG. 13. Leak collector 246 includes passages 255. Passages 255 include openings 256. One of openings 256 can be aligned with a corresponding one of weep holes 240 in valve 100. Passages 255 carry leaked gas received from weep holes 240 of valve 100 to a fluid line connected to tube stub 250. At each of openings 256, an O-ring 257 seals the interface between the opening 256 and a corresponding weep hole 240 on body 102 of valve 100.

FIG. 15 is a perspective view showing the back side of leak collector 246. Leak detector body 247 defines fastener holes 258 and glands 259. Each of fastener holes 257 can receive one of fasteners 251. Openings 256 are on back surface 260 of leak detector body 247. Glands 259 can each hold one of O-rings 257 (shown in FIG. 14) to seal the interface between openings 256 and corresponding weep holes 240 when leak collector 246 is secured to valve 100.

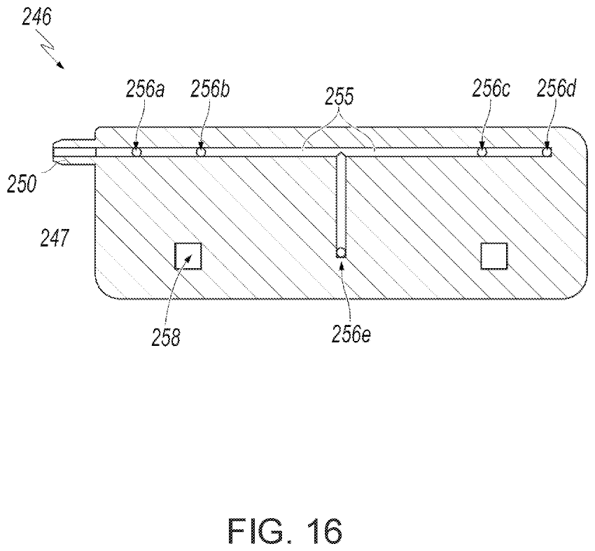

FIG. 16 is a cross sectional view of leak collector 246 taken along lines 16-16 of FIG. 15. Passages 255 provide fluid communication between openings 256a, 256b, 256c, 256d, and 256e and tube stub 250. In the example shown in FIG. 16, all of the openings 256 are commonly connected by passages 255. In other implementations, a leak collector can include separate passages for different openings and/or groups of openings. For example, in an alternate implementation, openings 256a, 256b, 256c, and 256d are in fluid communication with one tube stub, and opening 256e is in fluid communication with another tube stub. In this manner, a leak detection system can separately detect leakage from different weep holes or groups of weep holes. In another implementation, each of openings 256a, 256b, 256c, and 256d, and 256e is in fluid communication with a separate tube stub.

Leak collector 246 serves as a manifold for collecting gas leaking from weep holes or other leak points in valve 100. A leak detection system can separately collect and report information on leakage from specific leak points or groups of leak points on valve 100. In some implementations, a leak collector is coupled to handle assembly 104 to collect gas from leakage from weep hole 240f at handle assembly 104.

Stiffening ridges 249 may maintain flatness of leak collector 246 and facilitate sealing by O-Rings 257. In some implementations, leak detector 246 is injected molded. In other implementations, leak detector 246 is produced using 3-D printing, such as stereolithography. In one example, body 247 is about 5/16 inches thick and passages 274 are about 0.094 inches in diameter.

In some implementations, a valve includes a handle locking device. The handle locking device can inhibit rotation of a valve handle to open or close the valve. The handle locking device can include a locking pin.

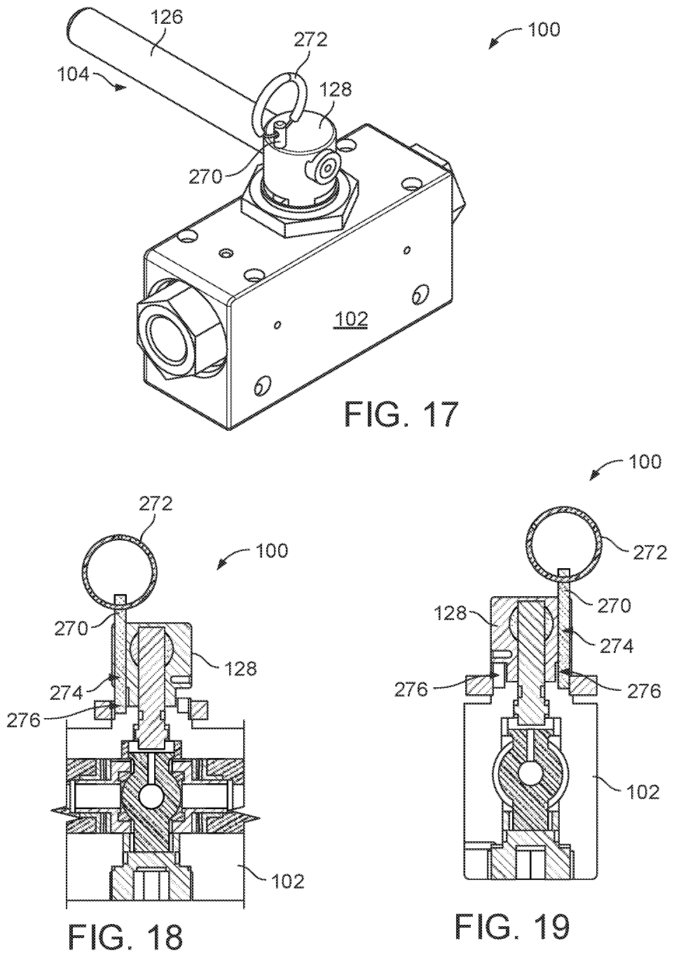

FIG. 17 is a perspective view illustrating one implementation of a handle locking device that can be used in valve 100 of FIGS. 1 and 2. Valve 100 includes pin 270 and finger ring 272. Finger ring 272 is coupled to pin 270. In certain implementations, finger ring 272 is connected to housing 102 or another part of valve 100 by way of a lanyard.

FIG. 18 is a cross sectional view of the valve 100 with the handle locking device of FIG. 17 with the ball valve in a closed position.

Hub 128 of handle assembly 104 includes holes 274. Holes 274 pass through hub 128 from top to bottom of hub 128. Housing 102 includes sockets 276 on top of housing 102 (see also FIG. 2). Pin 270 can be positioned by a user in holes 274 of hub 128 and sockets 276 of housing 102 to selectively lock and unlock rotation of handle assembly 104.

In one example, housing includes four of sockets 276. The four sockets 276 can be evenly spaced about the centerline of hub 128 (90 degrees angular spacing between sockets).

Pin 270 can be slid through any one of holes 274 in hub 128. The end of pin 270 can slide into any of sockets 276 in housing 102. In the example shown in FIG. 18, pin 260 passes through hole 274 of hub 128 and terminates in socket 276 of housing 102. In this location, pin 270 prevents handle assembly 104 from rotating to leave the closed position.

FIG. 19 is a cross sectional view of the valve with the handle locking device of FIG. 17 with the ball valve in an open position. In this location, pin 270 prevents handle assembly 104 from rotating to move away from the open position.

Referring again to FIGS. 1 and 2, the orientation of handle assembly 104 can be reversed. For example, handle assembly 104 can be positioned so the closed position is either in front or behind the valve. (Regardless of handle assembly position, the valve can turn clockwise to close.) To reverse the handle assembly, set screw 132 (shown in FIG. 2) can be loosened to allow handle assembly 104 to be separated from the top of valve stem 130. Handle assembly 104 can be rearranged to change the direction of handle 126 by 180 degrees. Set screw 132 can be retightened with the handle assembly 104 in the new position.

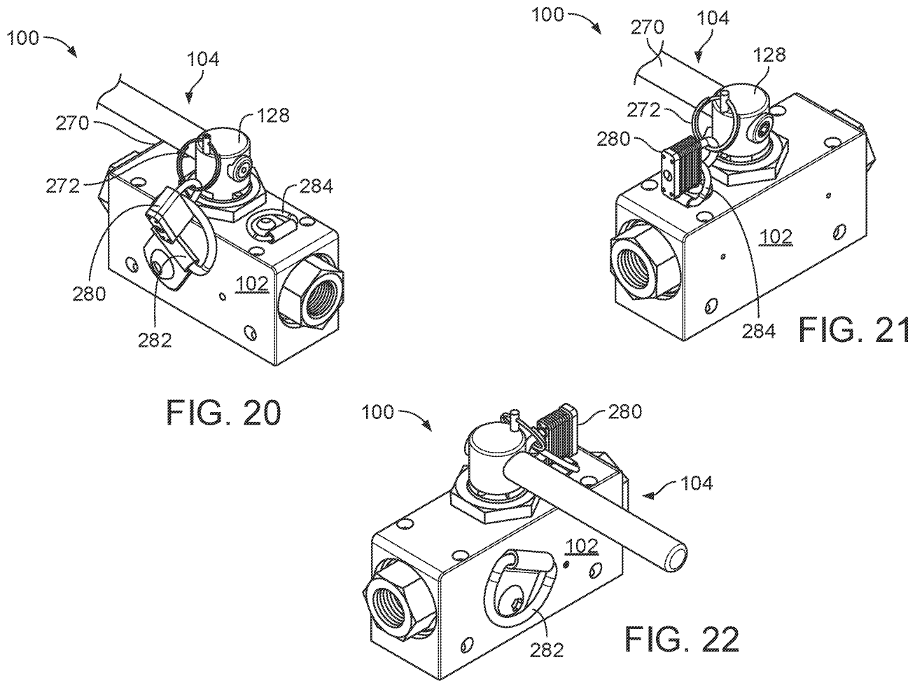

In some implementations, a valve includes a secondary lock. The lock can inhibit or prevent a handle locking device from being unlocked without removing the secondary lock. FIGS. 20, 21 and 22 are perspective views of a secondary locking system that can be used to prevent release of the handle locking device of FIGS. 17-19. Valve 100 includes padlock 280, side tie-down 282, and top tie-down 284. In this example, side tie-down 280 is coupled to a side surface of body 102. Top tie-down 284 is coupled to a top surface of body 102.

Padlock 280 can be used to lock ring 272 with respect to either one of side tie-down 282 and top tie-down 284. When ring 272 is locked to side tie-down 282 by padlock 280, valve 100 is held in the open position (FIG. 20). When ring 272 is repositioned and locked to top tie-down 284 using padlock 280, valve 100 is held in the closed position (FIG. 21). When handle assembly 104 is in the position shown in FIG. 21, side tie-down 282 can be repositioned below the upper surface of body 102, as shown in FIG. 22. Moving side tie-down 282 down can eliminate a finger-cutting hazard for operating the valve.

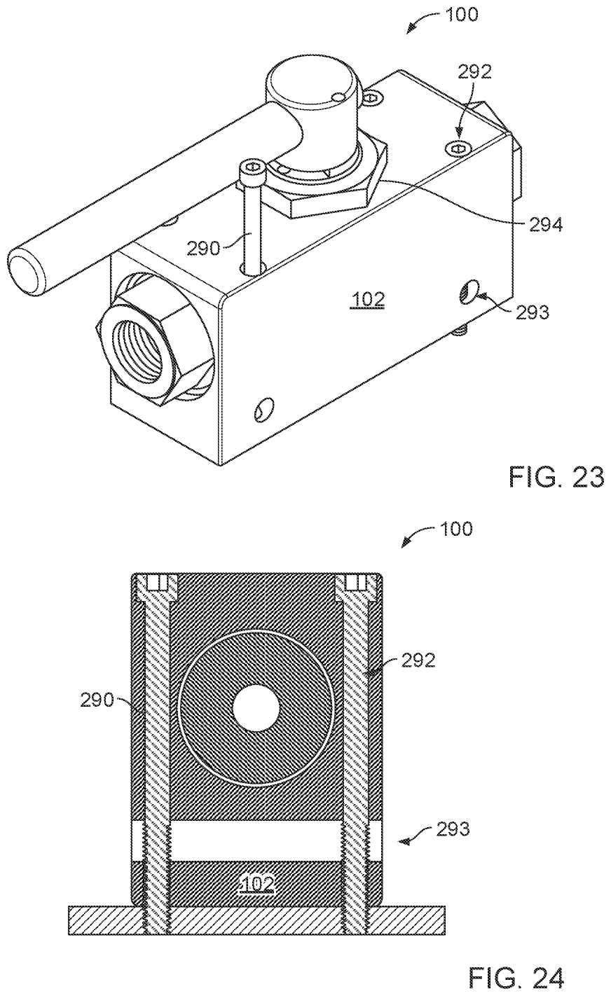

FIG. 23 is a perspective view illustrating mounting components of a valve. Valve 100 can be mounted to a flat surface using screws 290. Each of screws 290 may be installed in through-holes 292 defined in body 102 of valve 100. In this example, screws 290 are socket head cap screws. Screws 290 can be recessed below the upper surface of body 102 of valve 100. The bottom surface of body 102 can be in contact with the upper surface of the structure to which the valve is mounted (see FIG. 24). In this case, ball retainer 124 is inaccessible while the valve 100 is mounted, thereby preventing tampering or accidental removal of the ball retainer. In another implementation, valve 100 is mounted by installing screws through side thru holes 293. In still other implementations, valve 100 is panel-mounted at the upper surface of body 102 using panel nut 294.

Particular embodiments of the subject matter have been described. Other embodiments are within the scope of the following claims.

What is claimed is:

1. A valve, comprising:
a housing comprising:
an inlet;
an outlet;
a passage between the inlet and the outlet; and
a lower housing bore;
a ball rotatably coupled to the housing, the ball comprising:
a body;
a lower trunnion; and
an opening through the body;
a handle coupled to the ball and operable by a user to rotate the ball in the housing to align the opening with the passage of the housing to open the valve;
a ball retainer coupled to the housing and configured to retain the ball in the housing, the ball retainer comprising:
a threaded portion; and
a shaft portion at least partially disposed in the lower housing bore; and
a radial seal between the shaft portion and the lower housing bore.

2. The valve of claim 1, wherein:
the shaft portion of the ball retainer defines an external groove,
the radial seal is at least partially disposed in the external groove.

3. The valve of claim 1, wherein the external groove is beneath the threaded portion of the ball retainer.

4. The valve of claim 1, further comprising a seal back-up ring, wherein the seal back-up ring is configured to inhibit the radial seal from being displaced under pressure.

5. The valve of claim 4, wherein:
the shaft portion of the ball retainer defines an external groove,
the radial seal and the seal back-up ring are at least partially disposed in the external groove, and
the seal back-up ring is configured to inhibit the radial seal from being displaced from the external groove under pressure.

6. The valve of claim 1, wherein the radial seal comprises an O-ring.

7. The valve of claim 1, further comprising one or more ball seals configured to bear against the body of the ball, wherein at least one of the one or more ball seals comprises PEEK.

8. The valve of claim 1, further comprising one or more ball seals configured to bear against the body of the ball, wherein at least one of the one or more ball seals comprises a PEEK material reinforced with PTFE, graphite, and carbon fiber.

9. The valve of claim 1, further comprising one or more ball seals configured to bear against the body of the ball, wherein at least one of the one or more ball seals forms a spherical face seal with the ball.

10. The valve of claim 1, wherein:
the ball retainer defines a retainer bore in which at least a portion of the lower trunnion resides, and
the lower trunnion is configured to rotate in the retainer bore.

11. The valve of claim 10, further comprising a bearing between an outer surface of the lower trunnion and an inner surface of the retainer bore.

12. The valve of claim 1, further comprising one or more adapters coupled in at least one of the inlets and the outlets of the housing.

13. The valve of claim 12, further comprising one or more adapter retaining rings, wherein at least one of the one or more adapter retaining rings is configured to inhibit at least one of the one or more adapters from backing out of the housing under pressure.

14. The valve of claim 13, wherein the at least one adapter retaining ring comprises an internal retaining ring.

15. The valve of claim 12, wherein:
at least one of the adapters comprises a threaded portion and a shaft portion,
the shaft portion comprises an adapter external groove, and
the valve further comprises an adapter radial seal disposed in the adapter external groove.

16. The valve of claim 15, wherein the radial seal is beneath the threaded portion of the adapter.

17. The valve of claim 15, further comprising a seal back-up ring at least partially disposed in the adapter external groove, wherein the seal back-up ring is configured to inhibit the adapter radial seal from being displaced from the adapter external groove under pressure.

18. The valve of claim 12, wherein:
at least one of the one or more adapters comprises an adapter bore, and
the valve further comprises:
a ball seal on at least one side of the ball;
a ball seal carrier configured to hold the ball seal; and
a carrier radial seal between the an outer surface of the ball seal carrier and an inner surface of the adapter bore.

19. The valve of claim 18, further comprising a seal back-up ring configured to inhibit the carrier radial seal from being displaced under pressure.

20. The valve of claim 1, wherein an exterior surface of the ball retainer is flush with or recessed from a bottom surface of the housing.

21. The valve of claim 1, further comprising:
a stem between the ball and the handle and passing through an upper bore of the housing, the stem comprising a stem external groove; and
a stem radial seal at least partially disposed in the stem external groove.

22. The valve of claim 21, further comprising a seal back-up ring at least partially disposed in the stem external groove, wherein the seal back-up ring is configured to inhibit the stem radial seal from being displaced from the stem external groove under pressure.

23. The valve of claim 1, wherein the ball comprises an upper trunnion.

24. The valve of claim 1, wherein:
the housing defines one or more weep holes, and
at least one of the one or more weep holes comprises an opening on an exterior surface of the housing in fluid communication with at least one seal of the valve.

25. The valve of claim 24, wherein at least one of the one or more weep holes is configured to permit detection of leaks from the valve.

26. The valve of claim 1, wherein:
the housing defines two or more weep holes, and
at least two of the two or more weep holes comprises an opening on the exterior surface of the housing.

27. The valve of claim 26, wherein the valve comprises two or more radial seals, wherein each of at least two of the two or more weep holes is in fluid communication with a different one of the two or more radial seals.

28. The valve of claim 26, wherein:
at least one of the openings is in fluid communication with a radial seal of the valve, and
at least one of the openings is in fluid communication with a cone or threads of an adapter coupled in the housing.

29. The valve of claim 1, further comprising a pin removably coupled to the handle, wherein the pin is configurable to lock a position of the valve.

30. The valve of claim 29, wherein the pin is configured to pass through an opening in the handle to lock the position of the valve.

31. The valve of claim 29, further comprising a finger ring coupled to the pin.

32. The valve of claim 29, further comprising a lanyard coupled between the pin and the housing.

33. The valve of claim 29, further comprising a padlock configurable to lock the pin in place in the handle.

34. A valve, comprising:
a housing comprising:
an inlet;
an outlet;
a passage between the inlet and the outlet; and
one or more internally threaded portions;
a ball rotatably coupled to the housing, the ball comprising a through opening;
a handle coupled to the ball and operable by a user to rotate the ball in the housing to align the through opening with the passage of the housing to open the valve;
one or more components comprising a threaded portion, wherein at least one of the one or more components is coupled in one of the internally threaded portions of the housing; and
one or more radial seal sets configured to inhibit gas from leaking from the passage past the at least one component, at least one of the radial seal sets comprising:
a radial seal; and
a seal back-up ring configured to inhibit the radial seal from being displaced under pressure,
wherein at least one of the radial seals is beneath the threaded portion of the at least one component.

35. The valve of claim 34, wherein the at least one component comprises a ball retainer.

36. The valve of claim 34, wherein the at least one component comprises an inlet adapter.

37. The valve of claim 34, wherein:
the at least one component comprises a groove; and
the seal back-up ring is configured to inhibit the radial seal from being displaced from the groove under pressure.

38. A valve, comprising:
a housing comprising:
an inlet;
an outlet; and
a passage between the inlet and the outlet;
a ball rotatably coupled to the housing, the ball comprising a through opening;
a handle coupled to the ball and operable by a user to rotate the ball in the housing to align the through opening with the passage of the housing to open the valve;
one or more adapters threadably coupled to the housing; and
one or more adapter retaining rings, wherein at least one of the one or more adapter retaining rings is configured to inhibit at least one of the one or more adapters from backing out of the housing under pressure.

39. A valve, comprising:
a housing comprising:
an inlet;
an outlet; and
a passage between the inlet and the outlet;
a ball rotatably coupled to the housing, the ball comprising a through opening;
a handle coupled to the ball and operable by a user to rotate the ball in the housing to align the through opening with the passage of the housing to open the valve; and
two or more seals configured to inhibit gas from leaking from the passage,
wherein:
the housing defines two or more weep holes, at least two of the two or more weep holes comprising an opening on an exterior surface of the valve, and
each of at least two of the two or more weep holes is in fluid communication with a different one of the two or more seals.

40. A system for detecting leakage from a valve, comprising:
a leak detector; and
a leak collector comprising one or more passages in fluid communication with the leak detector;
wherein:
the leak collector is configured to collect gas leaked from one or more weep holes on the valve into at least one of the one or more passages; and
the leak detector is configured to detect leaks from the valve from the gas collector in the at least one passage in the leak collector.

41. The system of claim 40, wherein the leak collector is configured to collect gas leaked from two or more weep holes on a surface of the valve.
